(19) United States
(12) Patent Application Publication
(10) Pub. No.: US 2026/0079677 A1
(43) Pub. Date: Mar. 19, 2026

(54) Systems and Methods for Automatically Generating Software Code From a File

(71) Applicant: The PNC Financial Services Group, Inc., Pittsburgh, PA (US)

(72) Inventors: Saima SHAFIQ, Pittsburgh, PA (US); Harshal MULHERKAR, Pittsburgh, PA (US)

(21) Appl. No.: 19/265,040

(22) Filed: Jul. 10, 2025

Related U.S. Application Data
(60) Provisional application No. 63/669,521, filed on Jul. 10, 2024.

(51) Int. Cl. G06F 8/35

(52) U.S. Cl. CPC G06F 8/35

(57) ABSTRACT

Systems and methods are provided for automatically generating software code from a file that comprises a plurality of questions in plain text form. A first plain text question is accessed from the file. A first set of suggested answers is accessed from the file comprising a first suggested answer and a second suggested answer. A first set of routing information is accessed from the file, where the routing information includes a first subrouting associated with the first suggested answer and a second subrouting associated with the second suggested answer. A first software module is generated based on the first plain text question, the first suggested answer, the second suggested answer, and the routing information. A second plain text question, a second set of suggested answers, and a second set of routing information are accessed from the file. A second software module is generated based on the second plain text question, the second set of suggested answers, and the second set of routing information. A pointer from the first software module to the second software module is configured based on the first subrouting associated with the first suggested answer, and a first software package is outputted based on the first software module, the second software module and the pointer from the first software module to the second software module.

### CROSS-REFERENCE TO RELATED APPLICATIONS

This application claims priority to U.S. Provisional Application No. 63/669,521, entitled “SYSTEMS AND METHODS FOR AUTOMATICALLY GENERATING SOFTWARE CODE FROM A FILE,” filed Jul. 10, 2024, the entirety of which is herein incorporated by reference.

### FIELD

This disclosure is related generally to automated software generation and more particularly to automated software generation for self-help software.

### BACKGROUND

Authors of informative documents (e.g., help files for operating a computing system, question trees for instructing telephone help line operators) provide information to readers of those documents that help guide to resolution of user problems, significantly relieving frustration. These documents are typically structured in a question/answer format that guides the user toward a solution to their particular problem in as efficient a manner as possible. While these documents can be helpful to a user, they are often not written in a format that is optimum for human consumption. In list form, a series of questions is sub-optimal for getting to a solution in an optimum path. Where an intermediary person (e.g., a telephone operator) is necessary to guide a user through the informative document, cost is added to the process.

Software programs (e.g., a chat bot) can provide informative documents to users in an efficient fashion. But the writers of informative documents are often not skilled at writing software programs to take advantage of those efficiencies.

### SUMMARY

Systems and methods are provided for automatically generating software code from a file that comprises a plurality of questions in plain text form. A first plain text question is accessed from the file. A first set of suggested answers is accessed from the file comprising a first suggested answer and a second suggested answer. A first set of routing information is accessed from the file, where the routing information includes a first subrouting associated with the first suggested answer and a second subrouting associated with the second suggested answer. A first software module is generated based on the first plain text question, the first suggested answer, the second suggested answer, and the routing information. A second plain text question, a second set of suggested answers, and a second set of routing information are accessed from the file. A second software module is generated based on the second plain text question, the second set of suggested answers, and the second set of routing information. A pointer from the first software module to the second software module is configured based on the first subrouting associated with the first suggested answer, and a first software package is outputted based on the first software module, the second software module and the pointer from the first software module to the second software module.

As another example, a computer-implemented system for automatically generating software code from a file that comprises a plurality of questions in plain text form includes a file parsing engine configured to access a first plain text question from the file; access a first set of suggested answers from the file comprising a first suggested answer and a second suggested answer; and access a first set of routing information from the file, where the routing information includes a first subrouting associated with the first suggested answer and a second subrouting associated with the second suggested answer. A software generation module is configured to: generate a first software module based on the first plain text question, the first suggested answer, the second suggested answer, and the routing information; access a second plain text question, a second set of suggested answers, and a second set of routing information from the file; generate a second software module based on the second plaintext question, the second set of suggested answers, and the second set of routing information; configure a pointer from the first software module to the second software module based on the first subrouting associated with the first suggested answer; and output a first software package based on the first software module, the second software module and the pointer from the first software module to the second software module.

As a further example, a non-transitory computer-readable medium is encoded with instructions for commanding one or more data processors to execute a method for automatically generating software code from a file that comprises a plurality of questions in plain text form. In the method, a first plain text question is accessed from the file. A first set of suggested answers is accessed from the file comprising a first suggested answer and a second suggested answer. A first set of routing information is accessed from the file, where the routing information includes a first subrouting associated with the first suggested answer and a second subrouting associated with the second suggested answer. A first software module is generated based on the first plain text question, the first suggested answer, the second suggested answer, and the routing information. A second plain text question, a second set of suggested answers, and a second set of routing information are accessed from the file. A second software module is generated based on the second plain text question, the second set of suggested answers, and the second set of routing information. A pointer from the first software module to the second software module is configured based on the first subrouting associated with the first suggested answer, and a first software package is outputted based on the first software module, the second software module and the pointer from the first software module to the second software module.

### DESCRIPTION OF DRAWINGS

FIG. 1 is a diagram depicting a computer-implemented system for automatically generating software code from a file that comprises a plurality of questions in plain text form.

FIG. 2 depicts an example file that includes a plurality of questions in plain text form.

FIG. 3 is a diagram depicting further details of a computer-implemented system for automatically generating software code from a file that comprises a plurality of questions in plaintext form.

FIG. 4 is a diagram depicting presentation of a software package to a user via a user interface.

FIG. 5 is a diagram depicting an example processor identifying and executing a first software package.

FIG. 6 depicts using a language model during generation of a first software module.

FIGS. 7 and 8 provide a user interface depicting a user's interaction with a software package.

FIG. 9 is a flow diagram depicting a method for automatically generating software code from a file that comprises a plurality of questions in plain text form.

FIGS. 10A, 10B, and 10C depict example systems for implementing the approaches described herein for implementing a system for automatically generating software code from a file.

### DETAILED DESCRIPTION

As noted above, plain text files can provide helpful informational resources. Organizations often expend significant time and resources to drafting these documents to help their users (e.g., employees, customers) with resolving issues that they are facing. But as noted above, these documents are often suboptimal for providing information to the user, either in user time traversing the documents or in costs in presenting the documents (e.g., via an intervening telephone operator). Software programs can provide an efficient mechanism for presenting information, but those with software authoring expertise are often not the best person for generating the content of the text-containing files.

Systems and methods as described herein provide a computer-implemented method for automatically generating software code from a file that comprises a plurality of questions in plain text form. The file may be generated by a subject matter expert, such as a person knowledgeable with resolution of a common user problem (e.g., a web browser error 403 “Access Denied;” a lack of connectivity of a device to a router; a television that will not communicate with a connected DVD player, difficulty in completing a transaction on a bank or eCommerce website). The file may be created with the intention of automated creation of software code, or the file may be a legacy file created years prior for use in a different context (e.g., by a telephone operator). Systems and methods herein are configured to generate a software package based on the file that includes a plurality of questions in plain text form (e.g., a file that does not contain software code).

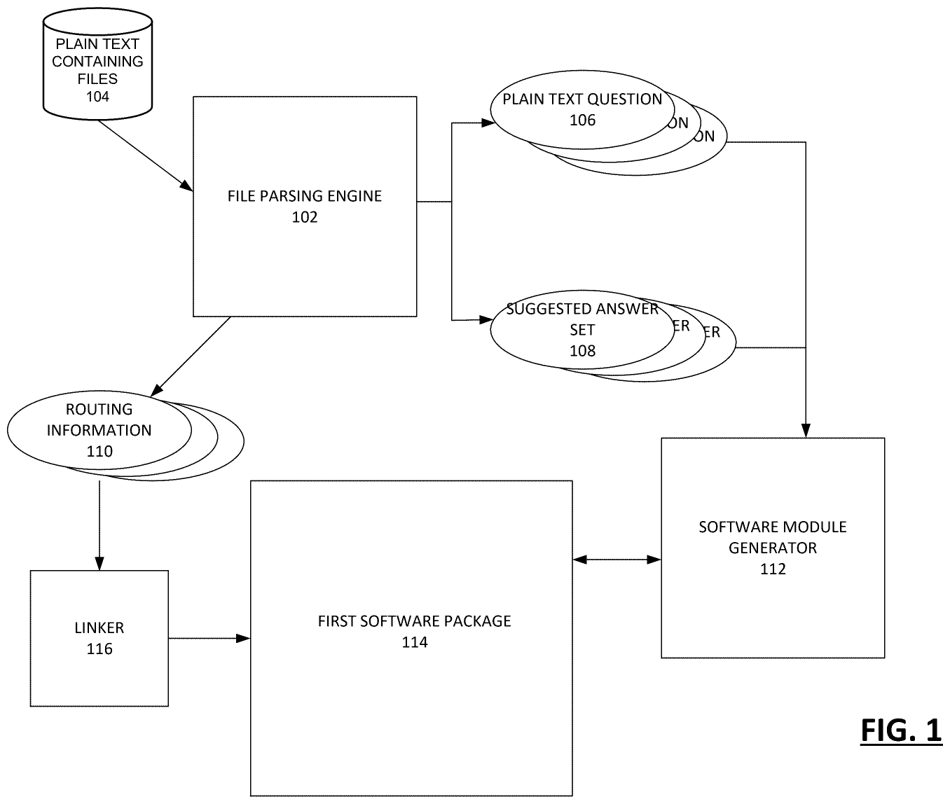

FIG. 1 is a diagram depicting a computer-implemented system for automatically generating software code from a file that comprises a plurality of questions in plain text form. A file parsing engine 102 accesses the file 104, such as from a disk, database, or other repository containing files. The file parsing engine 102 is configured to access plain text questions 106 from the file 104. The engine 102 further accesses suggested answers 108 from the file 104, where those suggested answers comprise at least a first suggested answer and a second suggested answer. The engine 102 further accesses routing information 110 from the file 104, where the routing information includes a first subrouting associated with the first suggested answer and a second subrouting associated with the second suggested answer. A software module generator 112 generates software modules that are incorporated into a software package 114 based on the plain text questions 106 and the suggested answer sets 108. As described further herein, a linker 116 links the software modules of the software package to one another based on the routing information 110.

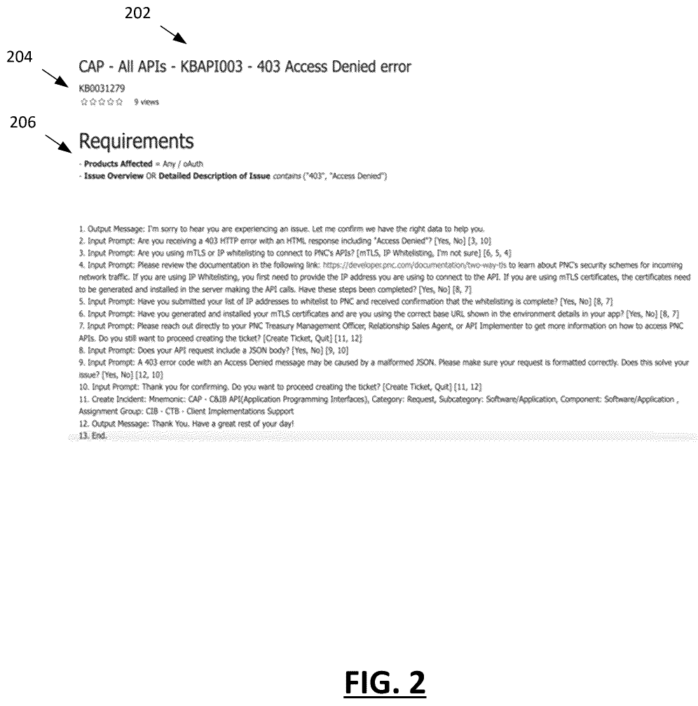

Files as contemplated in this disclosure may take a variety of forms including different formats (e.g., an Excel file, a text file, a Word document) and different formats and structures of data. FIG. 2 depicts an example file that includes a plurality of questions in plain text form. The file includes a title 202 that describes the contents of the file including its applicability (i.e., all application programming interfaces (APIs)) and a description of the issue that the file is intended to address (i.e., a 403 Access Denied error). The file includes an index for referencing the file in a knowledge base. The file further includes additional tags 206 that will further aid a user in locating the software package associated with the file of FIG. 2. The tags indicate that the file is associated with any product and that the file may be relevant when a search request topic includes the strings “403” or “access denied.”

The file then includes a series of lines, numbered sequentially 1-13. In the example of FIG. 2, each line includes an initial instruction followed by a colon (:) and then plain text associated with that instruction. (In some embodiments, the instruction (e.g., Output Message, Input Prompt, Create Incident, End) may be omitted on some or all of the lines, where outputting the plain text on the line is assumed as the intended instruction. ) For example, line 1 includes an Output Message instruction followed by the plain text, “I'm sorry to hear that you are experiencing an issue. Let me confirm that we have the right data to help you.” Some lines include further data following the plain text. Where no following data is presented (e.g., lines 1, 12), the intended flow of the file is to progress to the next line. Line 2 begins with an Input Prompt instruction followed by a plain text question, “Are you receiving a 403 HTTP error with an HTML response including ‘Access Denied’?” The plain text question is followed by a first delineator “[”. That first delineator indicates the start of a set of suggested answers. In line 2, the first suggested answer “Yes” and the second suggested answer “No” are extracted from a portion of line 2 that is between the first delineator “[” and a second delineator “]”. Following the second delineator associated with the set of suggested answers, a third delineator “[” indicates the start of routing information. In line 2, the routing information includes a first subrouting “3” associated with the first suggested answer “Yes” and second subrouting “10” associated with the second suggested answer “No.” The routing information ends with a fourth delineator “]”. The subroutings indicate to which line a reader should progress based on an answer from a reader. If the reader's answer exactly, or most closely matches “Yes,” then the reader should progress to line 3. If the reader's answer exactly, or most closely matches “No,” then the reader should progress to line 4. Using this routing information, a reader can most efficiently traverse the document to get to a solution to their issue without the need to read extraneous text that has no, or limited, applicability to their situation. The routing information provides a non-sequential path through the file, which may include loops (e.g., a loop back to a previously accessed line when a suggestion proposed by the file does not work). In some instances, a line may include more than two suggested answers and corresponding subroutings (e.g., line 3). In examples, the subroutings may include a catchall routing when a received response from a user does not match or is not close to any of the suggested answers. In other examples, a default subrouting may be applied when none of the suggested answers matches a user response (e.g., a routing to initiating a ticket, a routing back to the first software module, a routing to a search engine).

The file of FIG. 2 provides a number of Input Prompt instructions that provide questions to the reader and suggested steps to take to resolve the reader's issue, followed by a question of whether the suggestion resolved the problem. Certain lines may contain other instructions as well. For example, line 11 presents a “Create Incident” instruction that is accessed when the questions and suggestions of the other lines are otherwise unable to resolve the reader's issue. The Create Incident instruction generates a communication (e.g., an email to another support person, a help request ticket). That communication is pre-populated with information that may include an identification of the reader (e.g., a name, an email address) and information about the issue that the reader is having (e.g., the title 202 of the text file being traversed), a category, subcategory, component, and group associated with the file and the communication. This pre-population of information into the incident report can increase the efficiency with which the recipient of the communication (e.g., an IT support person) can respond and resolve the reader's issue.

All of the paths through the file of FIG. 2 eventually lead to line 12 via routing information or progression from line 11's Create Incident instruction. Line 12 includes an Output Message and is followed by line 13's End instruction.

As noted above, while a file, such as the one depicted in FIG. 2, can provide valuable information to a recipient (e.g., a reader having an issue accessing a knowledge base article, a user calling a help line and accessing the information via an intermediary help line operator). But that information may be provided in a less than optimally efficient manner.

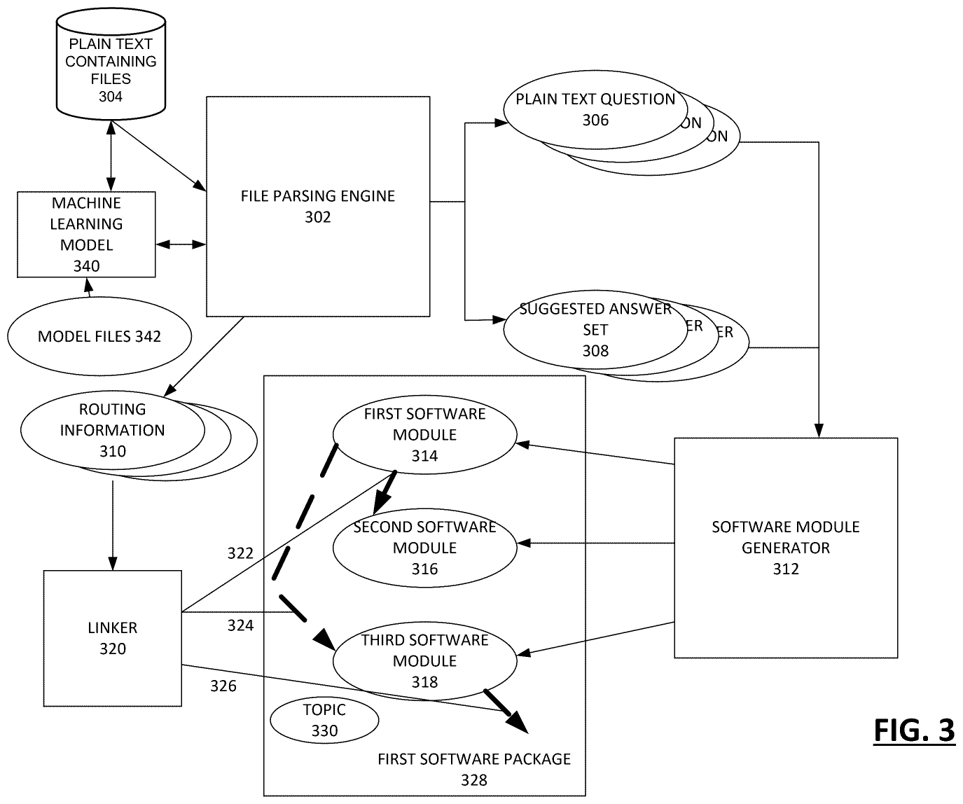

FIG. 3 is a diagram depicting further details of a computer-implemented system for automatically generating software code from a file that comprises a plurality of questions in plaintext form. A file parsing engine 302 accesses a first plain text question 306 from the file 304 (e.g., “Are you receiving a 403 HTTP error with an HTML response including ‘Access Denied’?” from line 2 of the file of FIG. 2). The engine 302 further accesses a first set of suggested answers 308 from the file 304, where the first set of suggested answers include a first suggested answer and a second suggested answer (e.g., “Yes” and “No,” respectively from between the first and second delineators of line 2). The parsing engine 302 further accesses a first set of routing information 310 from the file 304 (e.g., 3, 10, respectively from between the third and fourth delineators of line 2). The routing information 310 includes a first subrouting associated with the first suggested answer and a second subrouting associated with the second suggested answer.

A software generator 312 generates a first software module 314 based on the first plain text question 306 and the first set of suggested answers 308 parsed from the file 304. The first software module 314 contains instructions or other information to output text (e.g., “Are you receiving a 403 HTTP error with an HTML response including ‘Access Denied’?”) to a user and to wait to receive a response (e.g., some exactly or close to one of the suggested answer set members “Yes,”“No”).

The software modulator generator further generates a second software module 316 based on a second plain text question and a second set of suggested answers (e.g., from line 3). The second software module 316 contains instructions or other information to output text (e.g., “Are you using mTLS or IP whitelisting to connect to PNC's APIs?”) to a user and to wait to receive a response (e.g., some exactly or close to one of the suggested answer set members “mTLS,” “IP Whitelisting,” “I'm not sure”). The software module generator 312 is configured to generate n additional software modules (e.g., third software module 318), where in some examples the number of software modules generated corresponds with a number of lines in the file 304.

A linker 320 is configured to configure pointers among the software modules based on the routing information 310 extracted form the file. In the example of FIG. 3, the linker 320 configures a pointer 322 from the first software module 314 to the second software module 316 based on the first subrouting associated with the first suggested answer. A number (n) of other pointers 324, 326 are similarly configured among the software modules to implement the software flow identified by the sets of routing information 310 extracted from the file.

Having software modules 314, 316, 318 and pointers 322, 324, 326 generated and configured, respectively, the software module generator 312 combines those elements into a software package 328 for output. The software package 328 enables the modules and pointers to be collectively accessed and executed for use in presentation to a user, where text in a software module is provided to a user, the software module waits to receive a response that corresponds with a suggested answer, and traverses to a next software module via a pointer associated with the suggested answer that most closely matches the user response. In some examples, additional information may be integrated into the software package 328. In the example of FIG. 3, a topic 330 and other metadata information (e.g., from 202, 204, 206 of the file of FIG. 2, the entire raw text of the file) are included with the software package for use in locating the software package 328 in response to a user search request.

In some instances, the files 304 may be well formed for creating a software package 328. For instance, the example of FIG. 2 contains both text and routing information that is useful for discerning the content and routing of software modules 314, 316, 318 in the first software package 328. Some files may be less optimally structured. In such instances, a machine learning model 340 (e.g., a specifically trained or an untrained large language model) may be used to improve the structure of a file 304 prior to that file being provided to the file parsing engine 302. For example, the machine learning model 340 may be trained using examples from one or more model files 342, such as the one depicted in FIG. 2, that are considered to be well structured for forming the basis of a software package 328. The machine learning model 340 receives a file 304 that may not be optimally formatted (e.g., the file lacks routing information). Having been trained on exemplary model files 342 the machine learning model 340 augments the file to improve its utility as an input to the file parsing engine 302. An augmented version of the file is then provided to the file parsing engine 302. In embodiments, the file 304 is provided to the machine learning model 340 prior to being transmitted to the file parsing engine 302. In other examples, the file 304 is provided to the machine learning model under the direction of or based on a command from the file parsing engine 302.

The system of FIG. 3 may be used to generate a number of additional software packages, each software package being associated with a respective topic. Once one or more software packages are outputted from a system, a processor can interact with those software packages to present the software package to a user.

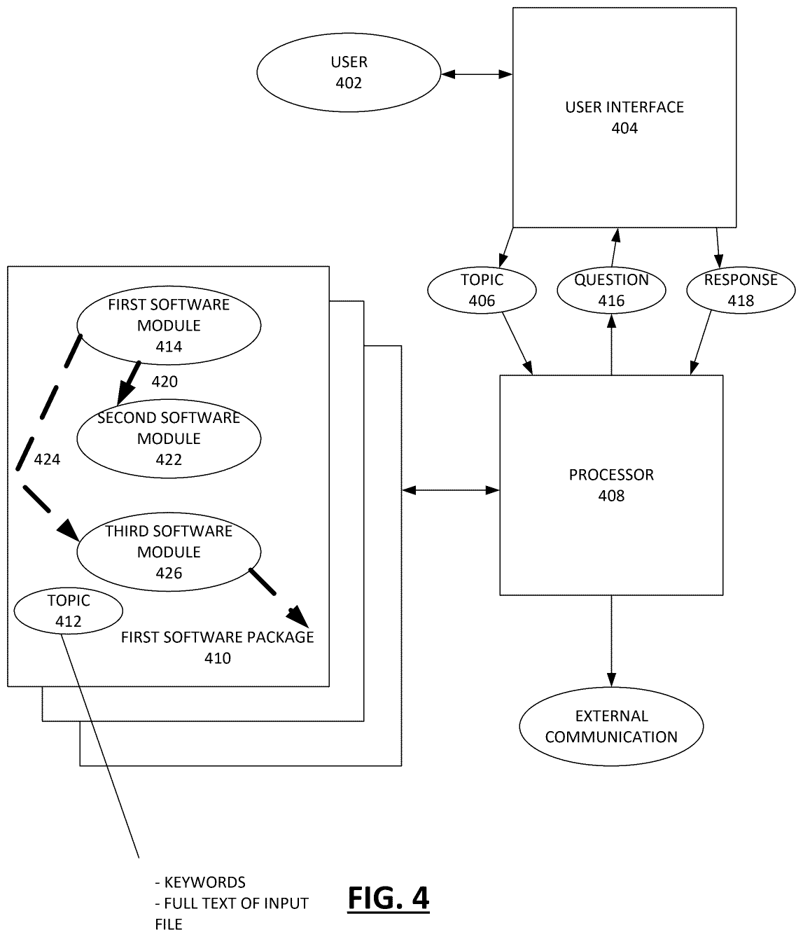

FIG. 4 is a diagram depicting presentation of a software package to a user via a user interface. In FIG. 4, a user 402 interacts with a user interface 404 to request information related to a topic 406 (e.g., requesting help with an Error 403, Access Denied error that they are receiving). The request topic 406 is received by a processor 408 that has access to a plurality of software packages that include the first software package 410. The processor 408 is configured to search the respective topic 412 and other metadata associated with the software packages to identify a particular software package with which the request topic 406 is most likely associated. One or more of the software packages are presented to the user 402 based on the request topic 406. In one example, presentation of a software package that is deemed a closest match is automatically started. In other examples, identifications of software packages are presented as search results (e.g., based on a topic, title, or other information associated with those software packages) for user selection.

Upon identifying a software package for execution (e.g., the first software package 410 identified in FIG. 4), the processor 408 executes the software modules therein. In the example of FIG. 4, the processor 408 executes the first software module 414. The processor accesses the first software module 414 and provides the first plain text question from the first software module to the user 402 via the user interface at 416. The processor 408 receive a first user response at 418. The processor 408 compares the first user response 418 to the first suggested answer and the second suggested answer stored within the first software module 414 and determines to which suggested answer the response 418 is closest (e.g., identifying an exact match, identifying a closest match based on a word distance calculation such as a Levenshtein distance). The processor then follows the pointer associated with the one of the first and second suggested answer with which the user response 418 best matches. For example, if the first suggested answer is an exact match, has the smallest distance to the user response 418, or otherwise has the highest match score, then the processor 408 follows the corresponding pointer 420 to the to the second software module 422. The processor 408 then accesses and executes the second software module 422, in most cases printing a text statement or question 416 and waiting for a further user response 418. Alternately, if the second suggested answer is determined to be the best match to the user response 418, then the processor 408 follows the corresponding pointer 424 to the to the third software module 426.

User input to a system may be received in a variety of ways. For example, the user may type text into a graphical user interface, detailing a topic that they need help with and then answers to questions presented via execution of a software package. In other instances, the user may communicate with a processor using mouse clicks or other interface device. In further examples, input to the processor may be automated via the user interface. For example, upon detection of a situation where a user might need help (e.g., upon detection of an error condition such as an occurrence of Error 403), or upon a user requesting help (e.g., via an “F1” key press) a user interface may capture data that is indicative of the issue that the user is having. In one example, optical character recognition is performed on a screen shot of the user interface display to detect key words that can be used as search terms for identifying a software package that contains information likely to help. In another example, a screen capture is provided to an image recognition module (e.g., a trained AI module, a vision system) to identify objects, error conditions, or other information associated with the screenshot to help identify software packages that may contain helpful information for the user. Further, as with other inputs described herein, a model such as an AI, large language, or other model can be used to expand an input to increase the likelihood of matches being identified (e.g., between a user request topic and a software package topic, between a user response and a suggested response in a software module).

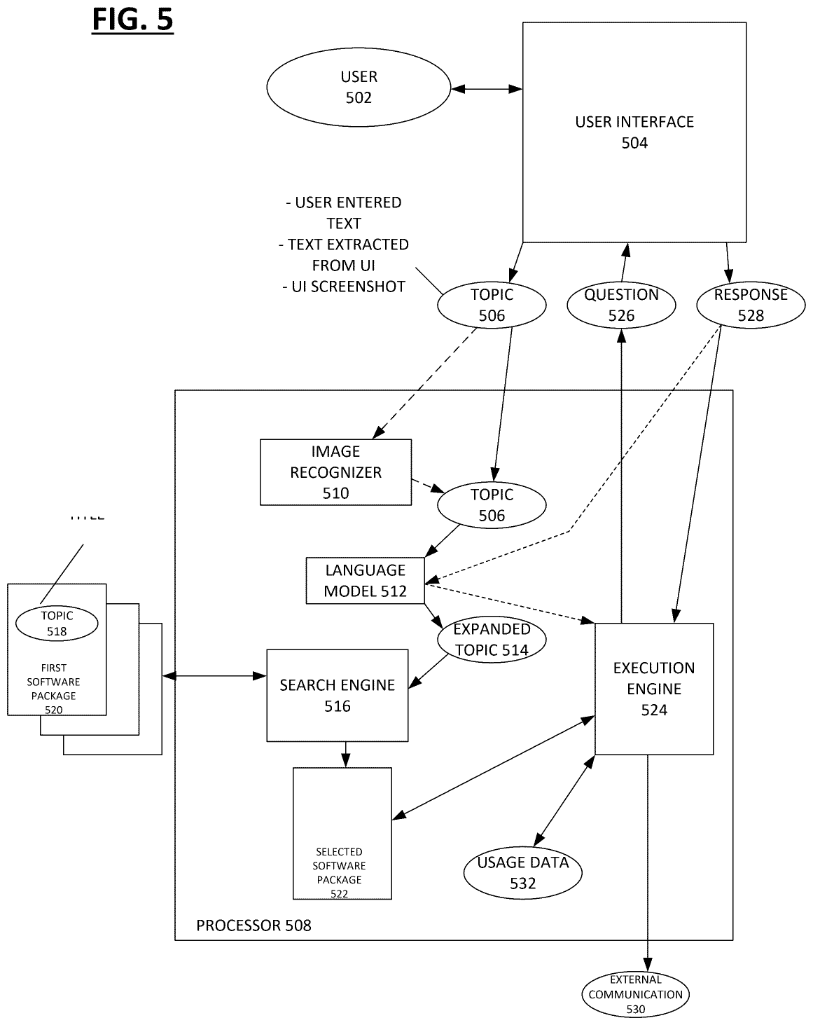

FIG. 5 is a diagram depicting an example processor identifying and executing a first software package. In FIG. 5, a user 502 interacts with a user interface 504 that is responsive to a processor 508. The user 502 affirmatively requests information regarding a topic 506, or the system detects that the user 502 needs information regarding that topic 506 based on information presented on the user interface 504 (e.g., an error condition presented). The topic 506 may be provided to the processor 508 in a variety of ways, such as via text entered by the user (e.g., search terms, a question entered in a text box); text extracted from the user interface 504 directly or via optical character recognition; or a screenshot of the user interface 504. In instances where the topic 506 is provided via a screenshot, an image recognizer 510 may analyze the screenshot and provide a text-based topic 506 that is suitable for use in searching for a software package having information relevant to the topic 506. The image recognizer 510 may provide text for the topic 506 by recognizing images in the user interface screenshot or using an artificial intelligence model trained on a large number (1000s or more) screenshot images and corresponding keywords associated with those training images. The topic 506 may further be provided to a language model 512 for expansion of the topic to form an expanded topic 514. The language model may be a large language model, artificial intelligence model, thesaurus, or other tool that is configured to augment, improve, or expand the language of the topic 506 (e.g., to include synonyms, to include other words that training examples have shown appeared in search strings that are similar to the topic 506. The expanded topic 514 (or the topic itself 506) are provided to a search engine 516. The search engine compares the topic 514 to topic information 518 associated with software packages including the first software package. The search engine 516 identifies one or more software packages that best match the topic 514. The software package deemed most relevant (or a choice from a search result list by the user 502) is deemed the selected software package 522.

An execution engine 524 presents the selected software package 522 to the user 502, such as described in the examples above. In instances where the selected software package 522 is configured to present a question/answer self-help file, the execution engine 524 presents a question 526 to the user 502 via the user interface 504 and receives a response 528. Based on the response 528, the execution engine 524 takes a next step as instructed by the selected software package 522. In some instances, the response 528 may be provided to the language model 512 (or another language model specifically trained for expanding responses in a similar context as response 528 (e.g., a question/answer chatbot implementation)). In some instances that next step will including presenting a next question 526 or other information to the user 502. In other instances, that next step may include transmitting an external communication 530 (e.g., an email to a technical support person, a communication initiating a help ticket).

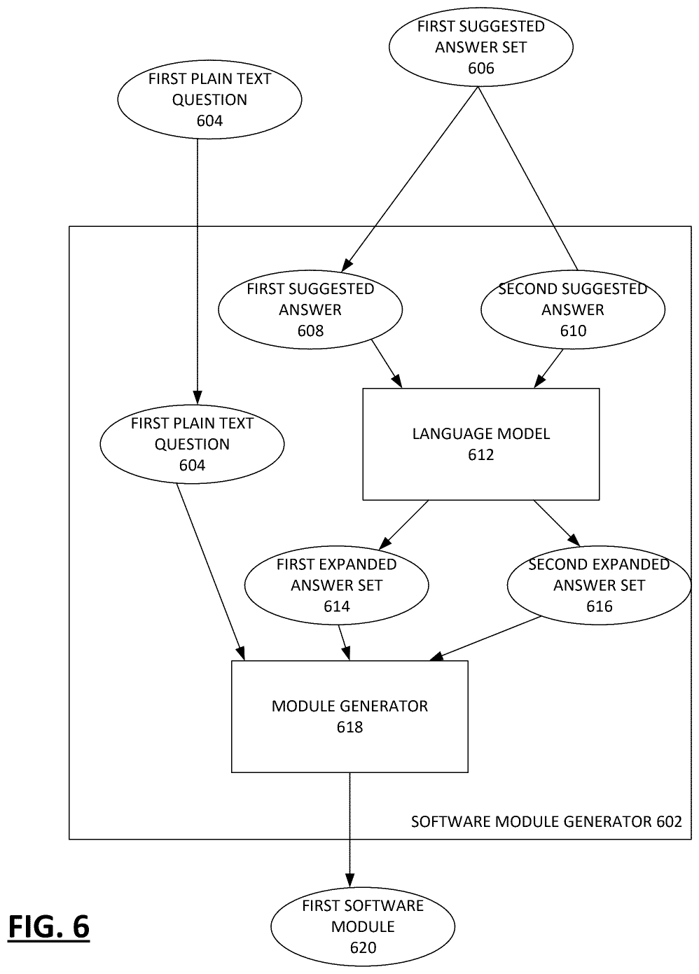

In some embodiments, the processor 508 may also track usage data 532 associated with execution of software packages. The usage data may track a wide variety of data including: a number of times a particular software package is returned as a search results, a number of times a particular software package is executed, counts of paths users take through a particular software package, counts of numbers of times particular nodes/steps of a particular software package are accessed, an amount of time particular software packages are accessed, success/failure rates of a particular software package in addressing a user problem. This usage data 532 can be used for tracking the effectiveness of individual software packages as well as the system overall.

Where FIG. 5 depicts using a language model to expand certain text during execution of a software package, language or other models (e.g., AI-based models) may be utilized at other phases of the process, such as during generation of software models. FIG. 6 depicts using a language model during generation of a first software module. A software module generator 602 receives a first plain text question 604 and a first suggested answer set 606 from a file. The first suggested answer set 606 includes a first suggested answer 608 and a second suggested answer 610 to the first plain text question 604. The first 608 and second 610 suggested answers are provided to a language model 612 which expands those suggested answers 608, 610 to generate a first expanded answer set 614 and a second expanded answer set 616 (e.g., first suggested answer 608 “Yes” is expanded at 614 to include “Yep, Yeah, Agree, Definitely, Of course, Sure, Agree, Roger, Aye, Affirmative”). The first plain text question 604, the first expanded answer set 614, and the second expanded answer set 616, the first expanded answer set 614 and the second expanded answer set 616 are utilized at 618 to generate a first software module 620.

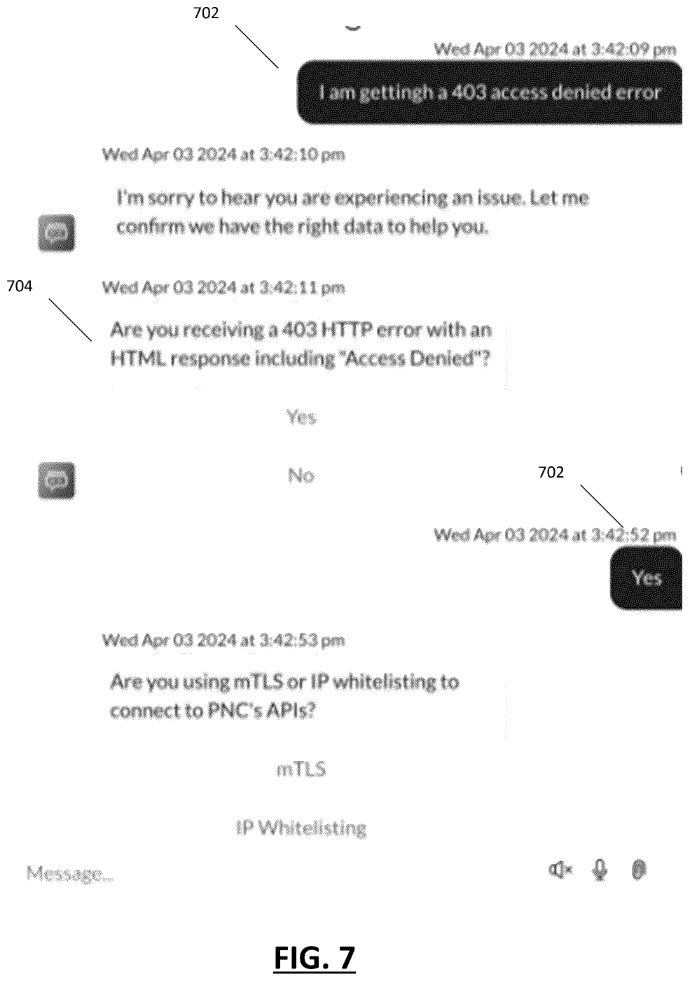

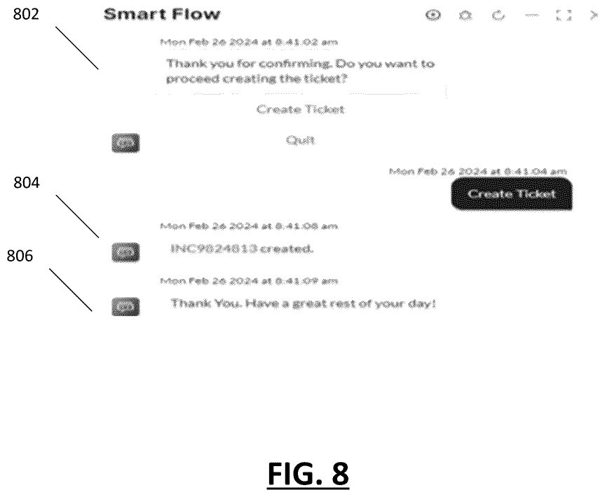

FIGS. 7 and 8 provide a user interface depicting a user's interaction with a software package. At 702, a user provides a help request that indicates an error that they are receiving. A system uses the string entered at 702 as a search string for identifying a particular software package that most likely contains information to help the user. The system performs a search based on the string 702 and automatically begins executing the software package deemed most relevant as a selected software package. At 704, the system presents a plain text question associated with a first software module within the selected software package. The system further presents a first suggested answer “Yes” and a second suggested answer “No” from that first software module. At 706, the user responds “Yes,” such as by clicking on one of the suggested answers at 704 (e.g., via a mouse, via a screen press on a mobile device) or typing the response on a keyboard or keypad or via voice recognition. Based on the response at 706, the system traverses to a next software module indicated by a pointer associated with the first suggested answer “Yes.” The system presents the plain text question associated with that next software module along with the first and second suggested answers associated with that next software module.

The process of FIG. 7 proceeds in an iterative fashion, with the hope of providing the user a resolution of their issue without needing third-person interaction. If such self-help is not accomplished, FIG. 8 depicts creation of a ticket via the chat box. When the system reaches a state where self-help does not appear to be practical, the user is provided an option at 802 to generate a ticket to a support person. When the user directs the system to generate a ticket, a pre-populated ticket is generated containing information about the user's issue so as to provide as prompt and efficient third-person support as possible. The user is provided a link to their ticket at 804 where they can review the content of their support ticket and its current status (e.g., awaiting review pending, resolved). Execution of the software package then terminates at 806.

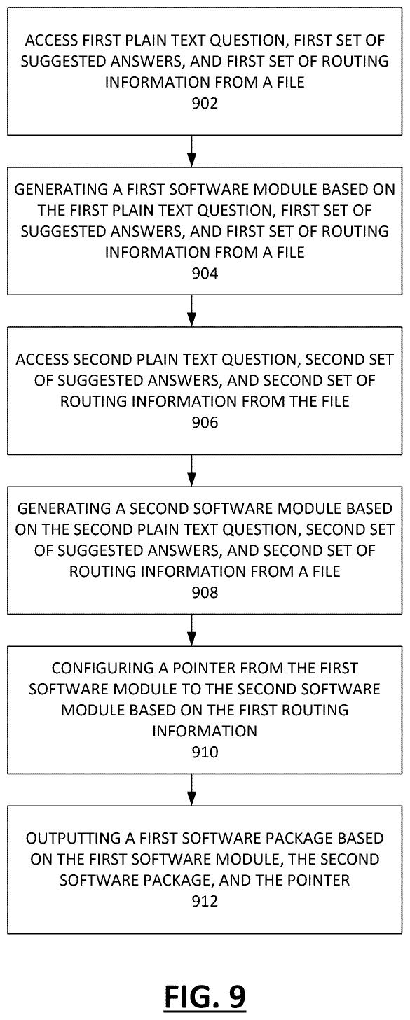

FIG. 9 is a flow diagram depicting a method for automatically generating software code from a file that comprises a plurality of questions in plain text form. At 902, a first plain text question is accessed from the file, a first set of suggested answers is accessed from the file comprising a first suggested answer and a second suggested answer, and a first set of routing information is accessed from the file, where the routing information includes a first subrouting associated with the first suggested answer and a second subrouting associated with the second suggested answer. At 904, a first software module is generated based on the first plain text question, the first suggested answer, the second suggested answer, and the routing information. At 906, a second plain text question, a second set of suggested answers, and a second set of routing information are accessed from the file. At 908, a second software module is generated based on the second plain text question, the second set of suggested answers, and the second set of routing information. At 910, a pointer from the first software module to the second software module is configured based on the first subrouting associated with the first suggested answer, and at 912, a first software package is outputted based on the first software module, the second software module and the pointer from the first software module to the second software module.

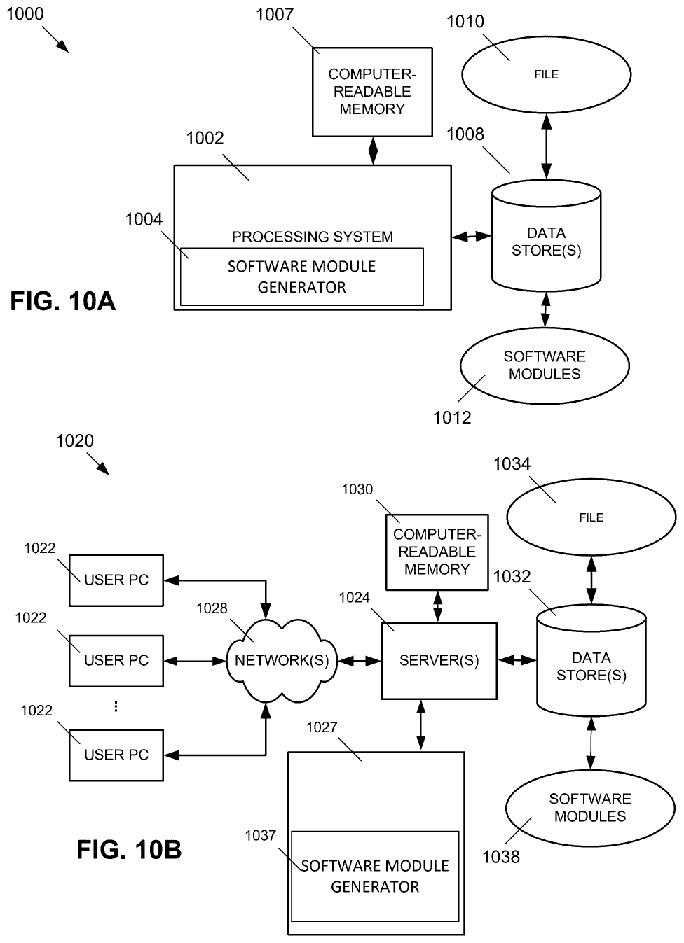

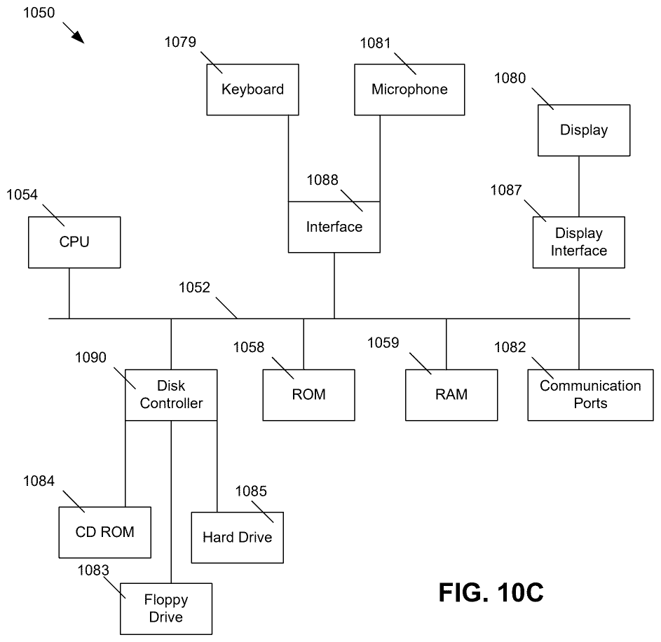

FIGS. 10A, 10B, and 10C depict example systems for implementing the approaches described herein for implementing a system for automatically generating software code from a file. For example, FIG. 10A depicts an exemplary system 1000 that includes a standalone computer architecture where a processing system 1002 (e.g., one or more computer processors located in a given computer or in multiple computers that may be separate and distinct from one another) includes a software module generator 1004 being executed on the processing system 1002. The processing system 1002 has access to a computer-readable memory 1007 in addition to one or more data stores 1008. The one or more data stores 1008 may include files 1010 as well as software modules 1012. The processing system 1002 may be a distributed parallel computing environment, which may be used to handle very large-scale data sets.

FIG. 10B depicts a system 1020 that includes a client-server architecture. One or more user PCs 1022 access one or more servers 1024 that include software module generator 1037 operating on a processing system 1027 via one or more networks 1028. The one or more servers 1024 may access a computer-readable memory 1030 as well as one or more data stores 1032. The one or more data stores 1032 may include files 1034 as well as software modules 1038.

FIG. 10C shows a block diagram of exemplary hardware for a standalone computer architecture 1050, such as the architecture depicted in FIG. 10A that may be used to include and/or implement the program instructions of system embodiments of the present disclosure. A bus 1052 may serve as the information highway interconnecting the other illustrated components of the hardware. A processing system 1054 labeled CPU (central processing unit) (e.g., one or more computer processors at a given computer or at multiple computers), may perform calculations and logic operations required to execute a program. A non-transitory processor-readable storage medium, such as read only memory (ROM) 1058 and random access memory (RAM) 1059, may be in communication with the processing system 1054 and may include one or more programming instructions for generating software modules. Optionally, program instructions may be stored on a non-transitory computer-readable storage medium such as a magnetic disk, optical disk, recordable memory device, flash memory, or other physical storage medium.

In FIGS. 10A, 10B, and 10C, computer readable memories 1007, 1030, 1058, 1059 or data stores 1008, 1032, 1083, 1084, 1088 may include one or more data structures for storing and associating various data used in the example systems. For example, a data structure stored in any of the aforementioned locations may be used to store data from XML files, initial parameters, and/or data for other variables described herein. A disk controller 1090 interfaces one or more optional disk drives to the system bus 1052. These disk drives may be external or internal floppy disk drives such as 1083, external or internal CD-ROM, CD-R, CD-RW or DVD drives such as 1084, or external or internal hard drives 1085. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1090, the ROM 1058 and/or the RAM 1059. The processor 1054 may access one or more components as required.

A display interface 1087 may permit information from the bus 1052 to be displayed on a display 1080 in audio, graphic, or alphanumeric format. Communication with external devices may optionally occur using various communication ports 1082.

In addition to these computer-type components, the hardware may also include data input devices, such as a keyboard 1079, or other input device 1081, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

It is claimed:

1. A computer-implemented method for automatically generating software code from a file that comprises a plurality of questions in plain text form, comprising:
accessing a first plain text question from the file;
accessing a first set of suggested answers from the file comprising a first suggested answer and a second suggested answer;
accessing a first set of routing information from the file, wherein the routing information includes a first subrouting associated with the first suggested answer and a second subrouting associated with the second suggested answer;
generating a first software module based on the first plain text question, the first suggested answer, and the second suggested answer;
accessing a second plain text question, a second set of suggested answers, and a second set of routing information from the file;
generating a second software module based on the second plain text question and the second set of suggested answers;
configuring a pointer from the first software module to the second software module based on the first subrouting associated with the first suggested answer;
outputting a first software package based on the first software module, the second software module and the pointer from the first software module to the second software module.

2. The method of claim 1, further comprising:
accessing a topic from the file; and
associating the topic with the first software package for locating the first software package.

3. The method of claim 1, further comprising:
providing the first suggested answer to a language model to generate a first expanded answer set;
providing the second suggested answer to the language model to generate a second expanded answer set;
wherein the first software module is generated based on the first expanded answer set and the second expanded answer set.

4. The method of claim 1, further comprising:
generating n additional software modules and m additional pointers for routing among the n additional software modules;
wherein first software package is further based on the n additional software modules and m additional pointers.

5. The method of claim 1, further comprising:
outputting additional software packages, each of the first software package and the additional software packages being associated with respective topics.

6. The method of claim 1, further comprising:
accessing a first line from the file;
extracting the first plain text question from the first line;
extracting the first suggested answer and the second suggested answer from the first line; and
extracting the first set of routing information from the first line.

7. The method of claim 6, wherein the first plain text question is extracted from a portion of the first line that precedes a first delineator;
wherein the first suggested answer and the second suggested answer are extracted from a portion of the first line that is between the first delineator and a second delineator; and
wherein the first set of routing information is extracted from a portion of the first line that is after the second delineator.

8. The method of claim 5, further comprising:
receive a user request that includes a request topic;
searching the respective topics associated with the software packages to identify a particular software package with which the request topic is most likely associated.

9. The method of claim 8, further comprising:
providing the request topic to a language model to generate an expanded request topic;
wherein said searching is based on comparisons of the expanded request topic to the respective topics.

10. The method of claim 8, wherein the request topic is received in text form from a user interaction with a user interface.

11. The method of claim 8, wherein the request topic is extracted from a screen capture of a user interface associated with the user.

12. The method of claim 8, wherein the request topic is determined by providing a screen capture of a user interface associated with the user to an image recognition model.

13. The method of claim 8, further comprising:
receiving a user selection of the particular software package as a selected software package, wherein the particular software package is the first software package;
accessing the first software module;
providing the first plain text question from the first software module to the user;
receiving a first user response;
determining that the first suggested answer is a closest match to the first user response;
following the pointer from the first software module to the second software module based on said determining; and
providing the second plain text question from the second software module to the user.

14. The method of claim 13, further comprising:
providing the first user response to a language module to generate an expanded response;
wherein said determining is based on the expanded response.

15. The method of claim 13, further comprising receiving a second user response;
wherein further action is taken based on the second user response and the second software module.

16. The method of claim 15, wherein the further action comprises sending a message to a person as an email or a help request ticket.

17. The method of claim 8, further comprising:
tracking accesses of the particular software package and a final software module accessed during each access of the particular software package for evaluation of the usefulness and effectiveness of the particular software package.

18. The method of claim 8, wherein the request topic is a computer-related topic for which the user is requesting help;
wherein the particular software package is executed as a chat bot to provide the user help with the request topic.

19. A computer-implemented system for automatically generating software code from a file that comprises a plurality of questions in plain text form, comprising:
a file parsing engine configured to:
access a first plain text question from the file;
access a first set of suggested answers from the file comprising a first suggested answer and a second suggested answer;
access a first set of routing information from the file, wherein the routing information includes a first subrouting associated with the first suggested answer and a second subrouting associated with the second suggested answer;
a software generation module configured to:
generate a first software module based on the first plain text question, the first suggested answer, and the second suggested answer;
access a second plain text question and a second set of suggested answers, and a second set of routing information from the file;
generate a second software module based on the second plain text question and the second set of suggested answers;
configure a pointer from the first software module to the second software module based on the first subrouting associated with the first suggested answer; and
output a first software package based on the first software module, the second software module and the pointer from the first software module to the second software module.

20. A non-transitory computer-readable medium encoded with instructions for commanding one or more data processors to execute a method for automatically generating software code from a file that comprises a plurality of questions in plain text form, the method comprising:
accessing a first plain text question from the file;
accessing a first set of suggested answers from the file comprising a first suggested answer and a second suggested answer;
accessing a first set of routing information from the file, wherein the routing information includes a first subrouting associated with the first suggested answer and a second subrouting associated with the second suggested answer;
generating a first software module based on the first plain text question, the first suggested answer, and the second suggested answer;
accessing a second plain text question, a second set of suggested answers, and a second set of routing information from the file;
generating a second software module based on the second plain text question and the second set of suggested answers;
configuring a pointer from the first software module to the second software module based on the first subrouting associated with the first suggested answer;
outputting a first software package based on the first software module, the second software module and the pointer from the first software module to the second software module.
